(19) United States
(12) Patent Application Publication
(10) Pub. No.: US 2009/0150438 A1
(43) Pub. Date: Jun. 11, 2009

(54) Export file format with manifest for enhanced data transfer

(75) Inventors: David Bradley Markisohn, Indianapolis, IN (US); Mark Stetzer, Noblesville, IN (US); David B. Aramant, Carmel, IN (US)

Correspondence Address: BAKER & DANIELS LLP / ROCHE, 300 NORTH MERIDIAN STREET, SUITE 2700, INDIANAPOLIS, IN, 46204, US

(73) Assignee: Roche Diagnostics Operations, Inc., Indianapolis, IN (US)

(21) Appl. No.: 11/999,867

(22) Filed: Dec. 7, 2007

(51) Int. Cl. G06F 17/00

(52) U.S. Cl. 707/104.1; 707/E17.044

(57) ABSTRACT

An export file format and a method and system for creating and accessing an export file. In one embodiment, the system includes a facility to import and export databases, in whole or in part. In one exemplary embodiment, the export files are used for transferring information between databases. In another exemplary embodiment, the export files are used to archive portions of databases.

### FIELD OF THE INVENTION

The present invention relates to an export file format and a method and system for creating and accessing the same.

### BACKGROUND OF THE INVENTION

Many fields of medical treatment and healthcare require monitoring of certain body functions. Thus, e.g., for patients suffering from diabetes, a regular check of the blood glucose level forms an essential part of the daily routine. The blood glucose level has to be determined quickly and reliably several times per day. Health monitoring devices are used to facilitate the collection of medical information without unduly disturbing the lifestyle of the patient. A large number of health monitoring devices for monitoring various body functions are commercially available.

Nevertheless, the use of health monitoring devices involves some risks which are mainly due to the complexity of using health monitoring devices. The risks are sometimes more pronounced for elderly patients or infants. Misuse of the health monitoring devices may lead to handling failures and to insufficient or even inaccurate information. Further, since many of the patients handling the health monitoring devices have not undergone medical training, the interpretation of the medical data collected by the health monitoring devices may be challenging to them. Often, patients are required to see their doctors in short time-intervals on a regular basis.

To reduce the frequency of necessary visits to doctors, the idea of home care gained popularity over the recent years. The availability of communication networks, such as the internet and wireless communication networks, led to the development of health management systems that enable transmission of patient medical data from the patient's home to a healthcare center by using health monitoring devices and data transfer systems. U.S. Pat. No. 7,103,578 and U.S. Published Application No. 2004/0172284 disclose two such methods and systems, the disclosures of which are incorporated by reference.

Known health management systems have several disadvantages. Some systems provide limited interaction capabilities to patients and care givers. Often, systems have limited analytical capabilities. Further, many health management systems do not permit collection of additional data or modification of data collected by the health management system. A need remains for systems that facilitate the use and interpretation of patient medical data.

### SUMMARY OF THE INVENTION

The present invention relates to an export file format and a method and system for creating and accessing an export file. In one embodiment, the system includes a facility to import and export databases, in whole or in part. In one exemplary embodiment, the export files are used for transferring information between databases. In another exemplary embodiment, the export files are used to archive portions of databases.

The export file of the present invention includes a manifest section that provides information about the data being transferred, both index data (typically a personal identifier key) and meta data (data about data, such as data formats, encryption information or hash values). In one exemplary embodiment, the manifest section includes an index of the patient information sections, encryption information about the patient information sections, and hash values for each of the patient information sections so that the integrity of such patient information may be tested. Additionally, the export file may also include a header section that contains typical header information.

In one exemplary embodiment, the export file further includes patient data sections that contain medical information for individual patients. The patient data sections may be provided in extensible format, such as XML formatting. In one exemplary embodiment, the patient information sections are encrypted. Additionally, the patient information sections may be compressed to reduce the overall file size.

### BRIEF DESCRIPTION OF THE DRAWINGS

The above-mentioned and other features of this invention, and the manner of attaining them, will become more apparent and the invention itself will be better understood by reference to the following description of an embodiment of the invention taken in conjunction with the accompanying drawings, wherein:

FIG. 1 is a schematic diagram of a health care management system;

FIG. 2 is a flowchart diagram view of a data migration process using the methodology of an exemplary embodiment of the present invention;

FIG. 3 is a screenshot of a source database type page according to an exemplary embodiment of the present invention;

FIG. 4 is a screenshot of a source database selection page according to an exemplary embodiment of the present invention;

FIG. 5 is a screenshot of a destination database selection page according to an exemplary embodiment of the present invention;

FIG. 6 is a screenshot of a check database warning page according to an exemplary embodiment of the present invention;

FIG. 7 is a screenshot of an options guide page according to an exemplary embodiment of the present invention;

FIG. 8 is a screenshot of a patient options page according to an exemplary embodiment of the present invention;

FIG. 9 is a screenshot of a physician options page according to an exemplary embodiment of the present invention;

FIG. 10 is a screenshot of a data migration process page according to an exemplary embodiment of the present invention;

FIG. 11 is a screenshot of a duplicate patient identification dialog according to an exemplary embodiment of the present invention;

FIG. 12 is a screenshot of a new medical management system identification prompt according to an exemplary embodiment of the present invention;

FIG. 13 is a screenshot of a duplicate healthcare provider dialog according to an exemplary embodiment of the present invention;

FIG. 14 is a screenshot of a data migration complete page according to an exemplary embodiment of the present invention;

FIG. 15 is a flowchart diagram of creating an export file according to an exemplary embodiment of the present invention; and

FIG. 16 is a schematic diagram of operations on the export file format according to an exemplary embodiment of the present invention.

Corresponding reference characters indicate corresponding parts throughout the several views. Although the drawings represent embodiments of various features and components according to the present invention, the drawings are not necessarily to scale and certain features may be exaggerated in order to better illustrate and explain the present invention. The exemplification set out herein illustrates embodiments of the invention, and such exemplifications are not to be construed as limiting the scope of the invention in any manner.

### DETAILED DESCRIPTION OF EMBODIMENTS OF THE INVENTION

For the purposes of promoting an understanding of the principles of the invention, reference will now be made to the embodiments illustrated in the drawings, which are described below. The embodiments disclosed below are not intended to be exhaustive or limit the invention to the precise form disclosed in the following detailed description. Rather, the embodiments are chosen and described so that others skilled in the art may utilize their teachings. It will be understood that no limitation of the scope of the invention is thereby intended. The invention includes any alterations and further modifications in the illustrated devices and described methods and further applications of the principles of the invention which would normally occur to one skilled in the art to which the invention relates.

The detailed descriptions which follow are presented in part in terms of algorithms and symbolic representations of operations on data bits within a computer memory representing alphanumeric characters or other information. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, symbols, characters, display data, terms, numbers, or the like. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory, rather they represent specific electronic structural elements which impart a physical organization on the information stored in memory. More than mere abstraction, the data structures are specific electrical or magnetic structural elements in memory which simultaneously represent complex data accurately and provide increased efficiency in computer operation.

Further, the manipulations performed are often referred to in terms, such as comparing or adding, commonly associated with mental operations performed by a human operator. No such capability of a human operator is necessary, or desirable in most cases, in any of the operations described herein which form part of the present invention; the operations are machine operations. Useful machines for performing the operations of the present invention include general purpose digital computers or other similar devices. In all cases the distinction between the method operations in operating a computer and the method of computation itself should be recognized. The present invention relates to a method and apparatus for operating a computer in processing electrical or other (e.g., mechanical, chemical) physical signals to generate other desired physical signals.

The present invention also relates to an apparatus for performing these operations. This apparatus may be specifically constructed for the required purposes or it may comprise a general purpose computer as selectively activated or reconfigured by a computer program stored in the computer. The algorithms presented herein are not inherently related to any particular computer or other apparatus. In particular, various general purpose machines may be used with programs written in accordance with the teachings herein, or it may prove more convenient to construct more specialized apparatus to perform the required method steps. The required structure for a variety of these machines will appear from the description below.

The present invention deals with “object-oriented” software, and particularly with an “object-oriented” operating system. The “object-oriented” software is organized into “objects,” each comprising a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects.

Messages are sent and received between objects having certain functions and knowledge to carry out processes. Messages are generated in response to user instructions, for example, by a user activating an icon with a cursor generating an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where the other objects are not allowed to access. One feature of the object-oriented system is inheritance. For example, an object for drawing a “circle” on a display may inherit functions and knowledge from another object for drawing a “shape” on a display.

A programmer “programs” in an object-oriented programming language by writing individual blocks of code each of which creates an object by defining its methods. A collection of such objects adapted to communicate with one another by means of messages comprises an object-oriented program. Object-oriented computer programming facilitates the modeling of interactive systems in that each component of the system can be modeled with an object, the behavior of each component being simulated by the methods of its corresponding object, and the interactions between components being simulated by messages transmitted between objects. Objects may also be invoked recursively, allowing for multiple applications of an objects methods until a condition is satisfied. Such recursive techniques may be the most efficient way to programmatically achieve a desired result.

Both programs and databases may be objects. In the case of databases, the data portion of the object may be significantly larger than the methods portion, The actual physical implementation of a database on a general purpose computer may take several forms, from complete individual records storing the substantive information with several key indexes for locating a particular record, to a plurality of tables interrelated by relational operations, to a matrix of cross-linked data records, to various combinations and hybrids of these general types. In particular physical devices, a database may be structured and arranged to accommodate the restrictions of the physical device—but when transferred to a general purpose computer be able to be stored in a variety of formats. Thus, while certain types of information may be described as being stored in a “database” from a conceptual standpoint, generally such information may be electronically stored in a variety of structures with a variety of encoding techniques.

Databases may contain many types of information, and may store the information in a variety of encoding techniques. When a database stores information that relates to a particular person, product, location, or other thing, the database typically uses a unique identifier that binds the “concept” of the person, product, location, or other thing with a storable piece of data. When the unique identifier is used to reference the data record, the unique identifier is termed a “key” and data records associated with the “concept” are said to be “keyed” by the unique identifier. The association between a key and its data may be implemented in a variety of ways, for example by having the key be a field in a corresponding data record, by having a key value in a search tree with an associated pointer to one or more data records corresponding to the key, or by encoding the corresponding information with a value that upon decoding produces the unique identifier and the corresponding data, etc. By these various methods, instances of data may be associated with, or “bound” with or to, the “concept” by using the key. A “key” of a data record is distinct from the “encryption key” which refers to a value used to encrypt data using an encryption algorithm.

The terms “network,” “local area network,” “LAN,” “wide area network,” or “WAN” mean two or more computers which are connected in such a manner that messages may be transmitted between the computers. In such computer networks, typically one or more computers operate as a “server,” a computer with large storage devices such as hard disk drives and communication hardware to operate peripheral devices such as printers or modems. Other computers, termed “workstations,” provide a user interface so that users of computer networks can access the network resources, such as shared data files, common peripheral devices, and inter-workstation communication. The computers have at least one processor for executing machine instructions, and memory for storing instructions and other information. Many combinations of processing circuitry and information storing equipment are known by those of ordinary skill in these arts. A processor may be a microprocessor, a digital signal processor (“DSP”), a central processing unit (“CPU”), or other circuit or equivalent capable of interpreting instructions or performing logical actions on information. Memory includes both volatile and non-volatile memory, including temporary and cache, in electronic, magnetic, optical, printed, or other format used to store information. Users activate computer programs or network resources to create “processes” which include both the general operation of the computer program along with specific operating characteristics determined by input variables and its environment.

Concepts described below may be further explained in one of more of the co-filed patent applications entitled HELP UTILITY FUNCTIONALITY AND ARCHITECTURE (Atty Docket: ROCHE-P0033), METHOD AND SYSTEM FOR GRAPHICALLY INDICATING MULTIPLE DATA VALUES (Atty Docket: ROCHE-P0039), SYSTEM AND METHOD FOR DATABASE INTEGRITY CHECKING (Atty Docket: ROCHE-P0056), METHOD AND SYSTEM FOR DATA SOURCE AND MODIFICATION TRACKING (Atty Docket: ROCHE-P0037), PATIENT-CENTRIC HEALTHCARE INFORMATION MAINTENANCE (Atty Docket: ROCHE-P0043), GRAPHIC ZOOM FUNCTIONALITY FOR A CUSTOM REPORT (Atty Docket: ROCHE-P0048), METHOD AND SYSTEM FOR SELECTIVE MERGING OF PATIENT DATA (Atty Docket: ROCHE-P0065), METHOD AND SYSTEM FOR PERSONAL MEDICAL DATA DATABASE MERGING (Atty Docket: ROCHE-P0066), METHOD AND SYSTEM FOR WIRELESS DEVICE COMMUNICATION (Atty Docket: ROCHE-P0034), METHOD AND SYSTEM FOR SETTING TIME BLOCKS (Atty Docket: ROCHE-P0054), METHOD AND SYSTEM FOR ENHANCED DATA TRANSFER (Atty Docket: ROCHE-P0042), COMMON EXTENSIBLE DATA EXCHANGE FORMAT (Atty Docket: ROCHE-P0036), METHOD OF CLONING SERVER INSTALLATION TO A NETWORK CLIENT (Atty Docket: ROCHE-P0035), METHOD AND SYSTEM FOR QUERYING A DATABASE (Atty Docket: ROCHE-P0049), METHOD AND SYSTEM FOR EVENT BASED DATA COMPARISON (Atty Docket: ROCHE-P0050), DYNAMIC COMMUNICATION STACK (Atty Docket: ROCHE-P0051), SYSTEM AND METHOD FOR REPORTING MEDICAL INFORMATION (Atty Docket: ROCHE-P0045), METHOD AND SYSTEM FOR MERGING EXTENSIBLE DATA INTO A DATABASE USING GLOBALLY UNIQUE IDENTIFIERS (Atty Docket: ROCHE-P0052), METHOD AND SYSTEM FOR ACTIVATING FEATURES AND FUNCTIONS OF A CONSOLIDATED SOFTWARE APPLICATION (Atty Docket: ROCHE-P0057), METHOD AND SYSTEM FOR CONFIGURING A CONSOLIDATED SOFTWARE APPLICATION (Atty Docket: ROCHE-P0058), METHOD AND SYSTEM FOR DATA SELECTION AND DISPLAY (Atty Docket: ROCHE-P0011), METHOD AND SYSTEM FOR ASSOCIATING DATABASE CONTENT FOR SECURITY ENHANCEMENT (Atty Docket: ROCHE-P0041), METHOD AND SYSTEM FOR CREATING REPORTS (Atty Docket: ROCHE-P0046), METHOD AND SYSTEM FOR CREATING USER-DEFINED OUTPUTS (Atty Docket: ROCHE-P0047), DATA DRIVEN COMMUNICATION PROTOCOL GRAMMAR (Atty Docket: ROCHE-P0055), HEALTHCARE MANAGEMENT SYSTEM HAVING IMPROVED PRINTING OF DISPLAY SCREEN INFORMATION (Atty Docket: ROCHE-P0031), and METHOD AND SYSTEM FOR MULTI-DEVICE COMMUNICATION (Atty Docket: ROCHE-P0064), the entire disclosures of which are hereby expressly incorporated herein by reference. It should be understood that the concepts described below may relate to diabetes management software systems for tracking and analyzing health data, such as, for example, the ACCU-CHEK® 360° product provided by Roche Diagnostics. However, the concepts described herein may also have applicability to apparatuses, methods, systems, and software in fields that are unrelated to healthcare. Furthermore, it should be understood that references in this patent application to devices, meters, monitors, pumps, or related terms are intended to encompass any currently existing or later developed apparatus that includes some or all of the features attributed to the referred to apparatus, including but not limited to the ACCU-CHEK® Active, ACCU-CHEK® Aviva, ACCU-CHEK® Compact, ACCU-CHEK® Compact Plus, ACCU-CHEK® Integra, ACCU-CHEK® Go, ACCU-CHEK® Performa, ACCU-CHEK® Spirit, ACCU-CHEK® D-Tron Plus, and ACCU-CHEK® Voicemate Plus, all provided by Roche Diagnostics or divisions thereof.

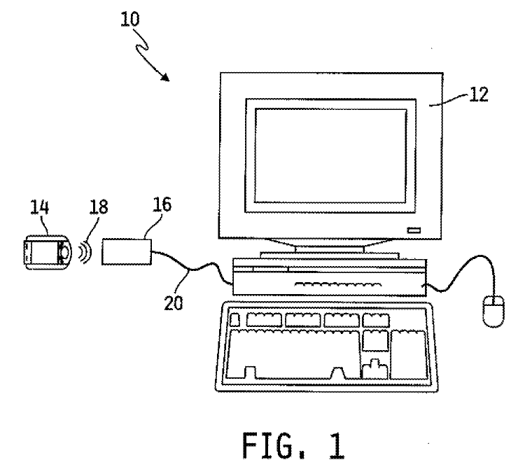

The present invention relates to an export file format and a method and system for creating and accessing an export file. For example, the present invention may be utilized to create and access an export file containing medical information that is used in conjunction with medical management software. In one exemplary embodiment, the medical information includes diabetes testing and/or treatment information for an individual patient. Referring to system 10, shown in FIG. 1, a patient may utilize portable medical device 14, which in one exemplary embodiment is a blood glucose monitor, to monitor and/or test various medical conditions, such as blood glucose levels, and record the measured conditions at various times. The information stored in portable medical device 14 may then be transferred to data collection device 16. Although blood glucose values measured at particular times are discussed herein, it should be understood that medical device 14 may be of a type for collecting other information such as A1c values, Albumin values, Albumin excretion values, body mass index values, blood pressure values, carbohydrate values, cholesterol values (total, HDL, LDL, ratio) creatinine values, fructosamine values, HbA1 values, height values, insulin dose values, insulin rate values, total daily insulin values, ketone values, microalbumin values, proteinuria values, heart rate values, temperature values, triglyceride values, and weight values. In one exemplary embodiment, the information is transferred from portable medical device 14 to data collection device 16 through infrared signal 18. Once the information is received by data collection device 16, it is transferred to computer 12 via communication cable 20. Although the software is described herein for operation on a computer (e.g., desktop, laptop or tablet), it should be understood that the principles of the invention may be embodied in software for operation on various devices, including but not limited to personal digital assistants (“PDAs”), infusion pumps, blood glucose meters, cellular phones, or integrated devices including a glucose measurement engine and a PDA or cellular device. The foregoing description of embodiments of the invention relate to information in the form of amount data with associated times, other embodiments are contemplated by the present invention that include time independent data, non-numerical data, and other combinations of types of data.

In another exemplary embodiment, portable medical device 14 may include a port for direct connection to communication cable 20. Computer 12 may be running medical management software, such as diabetes management software, and encrypt and save the medical information transferred from portable medical device 14 in one of a source format database or a destination format database. The information received from portable medical device 14 will be encrypted according to an encryption feature that is specific to portable medical device 14. Thus, if another portable medical device is used to upload information to computer 12, it will be encrypted according to the specific encryption feature of that device. Portable medical device 14 may also assign to the patient an external system identification that may be used to correlate the patient to a particular portable medical device. As the medical information is being uploaded to computer 12 or other storage media connected thereto, the present invention may be used to identify medical information stored in on portable medical device 14 that is unique thereto, a duplicate of, and/or a potential duplicate of medical information stored on computer 12 or other storage media connected thereto using the same or a substantially similar process as described in detail below with specific reference to a data migration utility.

A data comparison program may used in conjunction with the medical management software. The data comparison program may be in the form of a machine-readable program that is adapted to be utilized independent of or as an integral component of the medical management software. For example, the data comparison program may be formed as an object within the medical management software or, alternatively, may be stand alone software capable of independent operation and installation. In one exemplary embodiment, the data comparison program may be activated from the medical management software after the medical management software has been launched to compare a source database with a destination database. In another exemplary embodiment, the data comparison program may be utilized in conjunction with and/or formed as a component of a data migration utility. The data migration utility may also be in the form of a machine-readable program that is adapted to be utilized independent of or as an integral component of medical management software, such as diabetes management software. The operation of the data migration utility forms the basis of a corresponding U.S. Patent Application, entitled METHOD AND SYSTEM FOR PERSONAL MEDICAL DATA DATABASE MERGING, filed on even date herewith, the entire disclosure of which is expressly incorporated by reference herein. The operation of the data migration utility is set forth below and includes a detail description of the operation of the data comparison program in the context of the data migration utility. While described in detail herein with specific reference to the data migration utility, the data comparison program may be used as a stand alone component and/or at different points during a data transfer process and nothing contained herein should be viewed as limiting the scope of the invention to this exemplary embodiment.

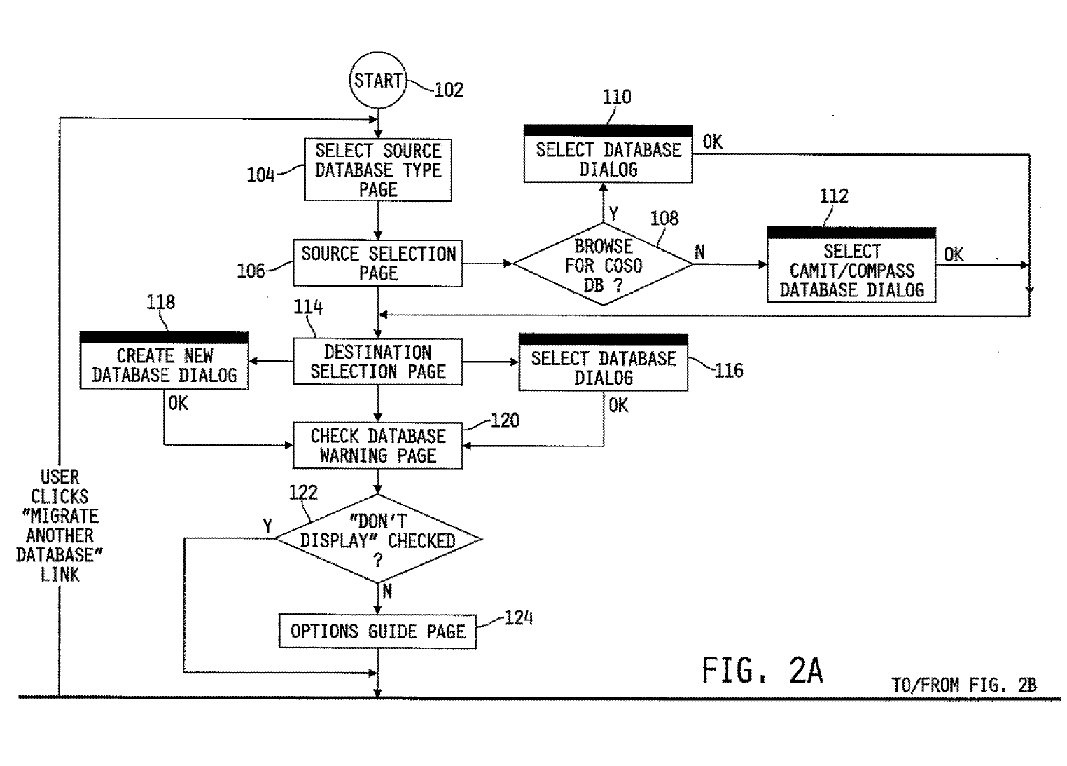

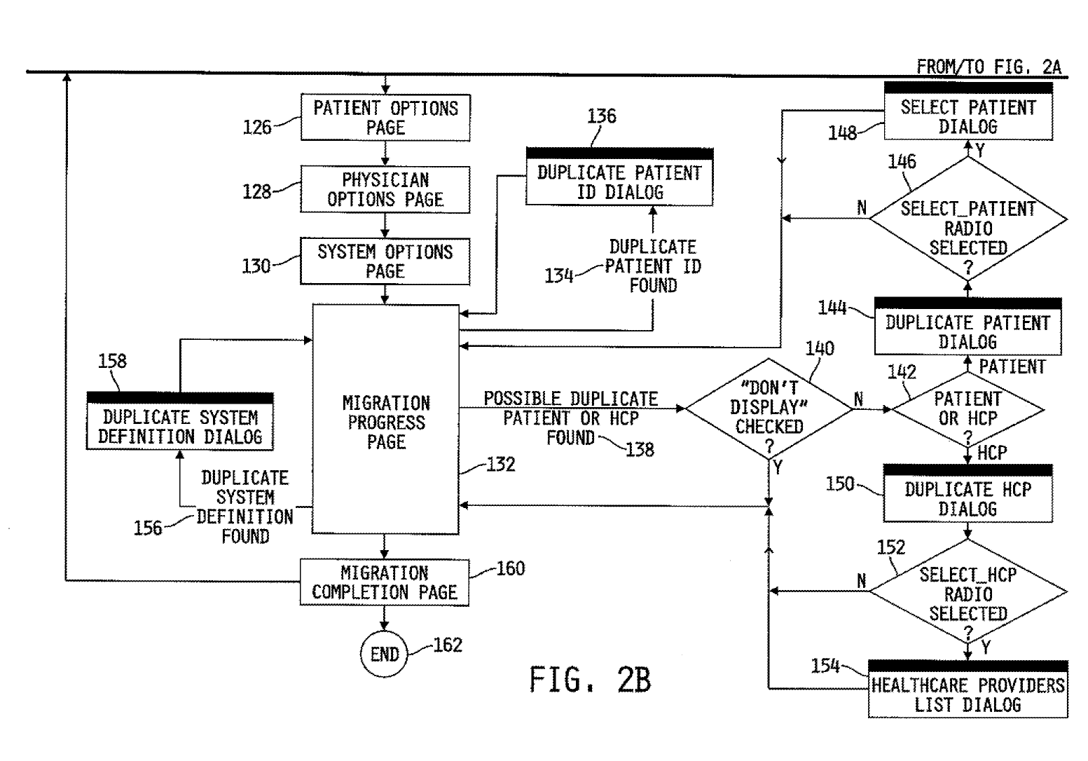

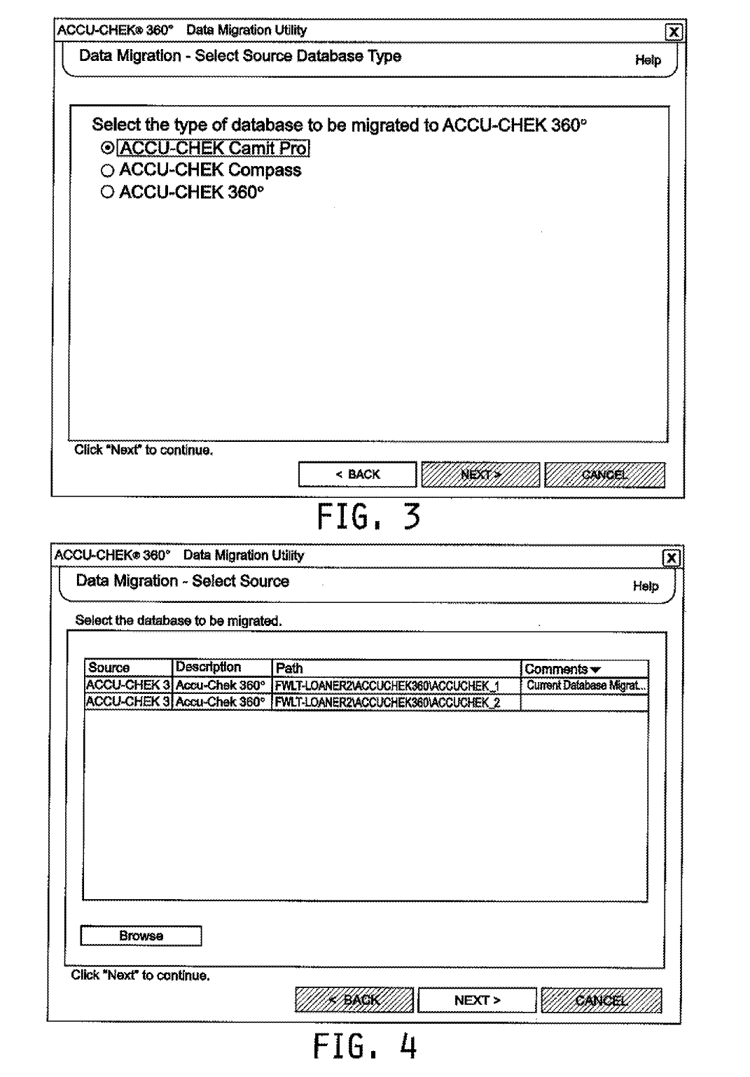

The data migration utility is utilized to migrate medical information in a source database to a destination database that may also contain medical information. Referring to FIG. 2, the data migration utility is launched at Start 102 on flowchart 100. In one exemplary embodiment, once the data migration utility is launched, a user may be prompted for information by dynamic questionnaires in a wizard format. For example, the user may be prompted to set the rules governing the migration of data. Referring to Step 104, the user may be prompted to select a source database stored in a source format for migration into a destination database stored in destination format at the source database type page shown in FIG. 3. The source database type page allows the user to select a database type from a list of various database types meeting the necessary requirements for migration into the destination database. For example, the database types listed may include only those databases that will be compatible with the medical management software once merged into a destination database and converted from source format into destination format.

In one exemplary embodiment, the medical management software is diabetes management software. Referring to FIG. 3, a list of databases that are compatible with the diabetes management software once merged into a destination database is provided. Specifically, as shown in FIG. 3, the source databases include, but are not limited to, databases associated with a glucose monitoring device or glucose monitoring software, such as those associated with ACCU-CHEK® Camit Pro, ACCU-CHEK® Compass, and ACCU-CHEK® 360°.

As shown in FIG. 3, positioned adjacent to each source database type displayed on the source database type page is a corresponding button. In one exemplary embodiment, only a single button may be selected at any given time. However, in other exemplary embodiments, multiple buttons may be selected for multiple, simultaneous database migration. By selecting the button corresponding to the desired source database type, a next or finish button may appear on the source database type page. By selecting the next or finish button, the user may progress to the next questionnaire in the data migration utility.

Once a source database type is selected and the user has also selected the next or finish button, the data migration utility displays a source database selection page at Step 106 in FIG. 2. Referring to FIG. 4, an exemplary source database selection page is shown that provides a listing of potential source databases by type and that may include general descriptions of the database, the file path for the database, and any comments relevant to the particular database. The source databases may be databases that contain medical information stored in a source format. For example, potential source databases may contain patient medical information that may further include numerous records associated with the individual patient having data fields for patient identity, including title, first name, middle name, last name, suffix, and date of birth, day and week information for the administration of medicine and/or for test results, such as blocks of time and days of week, targeted event information, contact information, such as address, phone number, and email address, emergency contact information, such as name, relation, address, and phone number, demographic information, such as diabetes diet, the diagnosis date, gender, and ethnicity, and diabetes therapy, such as controlled by and date and insulin type information, system identification, i.e., the patient's unique medical management system identification, external system identification, insurance, and healthcare provider data. Similarly, the databases may include healthcare provider information that may further include numerous records associated with healthcare providers having data fields such as healthcare provider title, first name, middle name, and last name, suffix, specialty, practice area, and contact information, such as address, phone number and email address, for example.

The source database selection page may also include a browse button, shown in FIG. 4, which allows a user to manually search the computer's hard drive or other attached media devices for a database location that is not listed on the source database selection page. Referring to Step 108 in FIG. 2, if the user selects the browse function at the source database selection page by selecting the browse button, Step 110 is executed and the user is prompted to select a file path for the source database. In contrast, if the user does not select the browse feature at Step 108, the user must then select one of the databases identified on the source selection page in step 106.

Irrespective of the method utilized to select the source database, once the source database is selected the data migration utility may then display a destination database selection page at Step 114. The destination database selection page may provide a listing of the potential destination databases stored in a destination format. In one exemplary embodiment, the potential destination databases are databases that are currently used by the medical management software. In one exemplary embodiment, the destination selection page may include a listing of the type of database, a description of each database, the file path for each database, and any comment related to each database. Additionally, the destination database may contain medical information, such as patient medical and/or healthcare provider information, and may include fields identical to or substantially identical to those set forth above with respect to the source database.

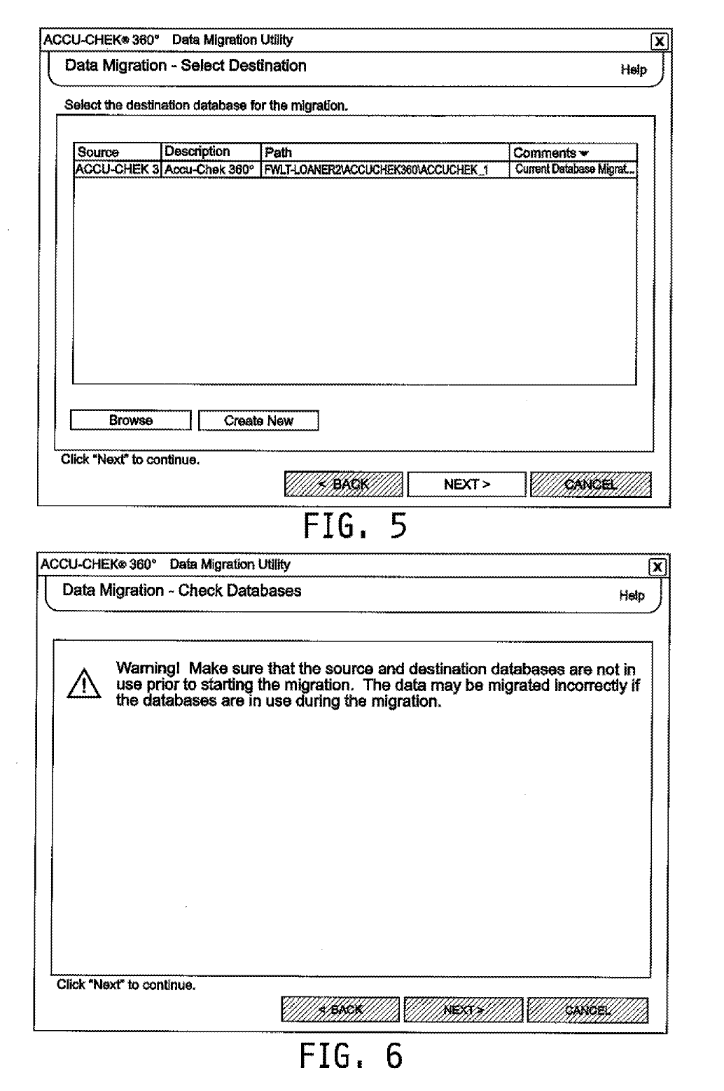

Referring to FIG. 5, which depicts an exemplary destination database selection page, the destination database selection page may include a browse button and/or create new button. If the browse button is selected, the user is directed to select a destination database in the same manner as in step 110 for selecting the source database. If the browse function is not selected, the user may either select one of the databases set forth on the destination database selection page by the data migration utility at Step 116 or, alternatively, the user may select the create new button. If the create new button is selected, a create new destination database dialog is activated at Step 118 and a new destination database is created. In one exemplary embodiment, the data migration utility further prompts the user to determine the file path where the new destination database is to be created. Additionally, the data migration utility may automatically assign the new destination database a file path that is associated with the corresponding medical management software.

Irrespective of the method utilized to select the destination database or whether a new destination database is created, a check database warning page is displayed at Step 120. An exemplary check database warning page is depicted in FIG. 6 and includes a warning to ensure that the source and destination databases are not in use prior to the start of data migration. In another exemplary embodiment, the check database warning page opened at Step 120 in FIG. 2 may further include a next or finish button that requires an affirmative action by the user before the data migration utility may initiate the migration of data from the source database to the destination database and, if necessary, conversion of the same from the source format to the destination format.

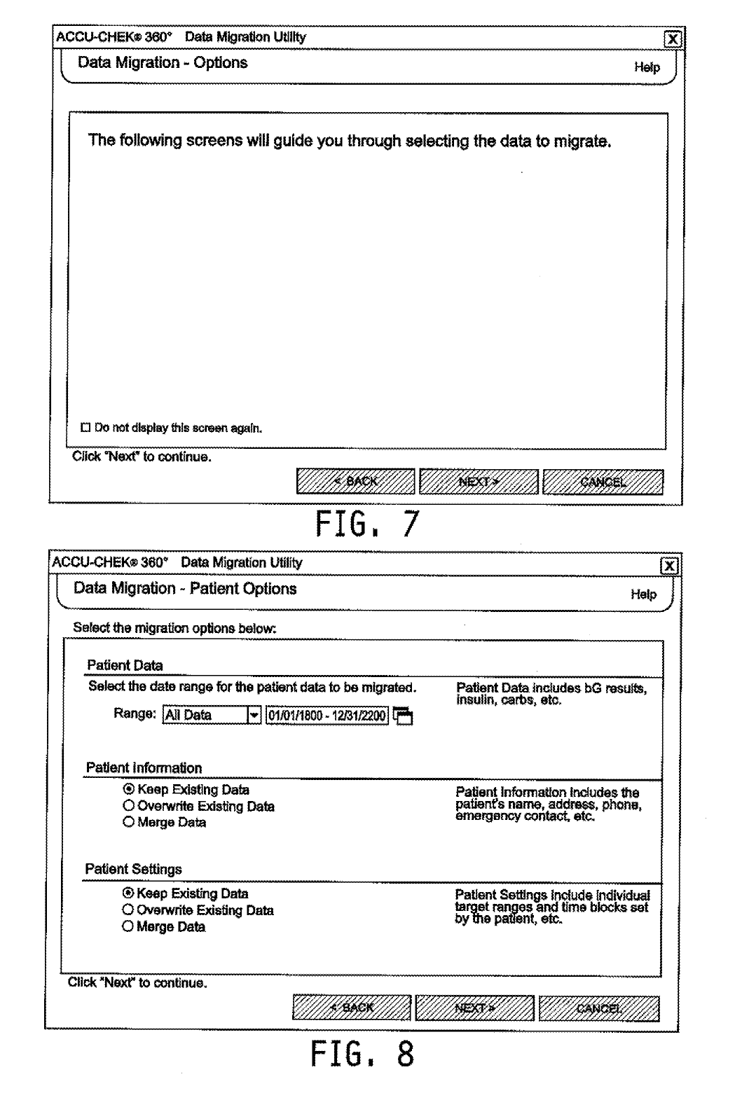

Once the next or finish button is selected, the data migration utility may open, at Step 124 in FIG. 2, an options guide page, shown in FIG. 7, to begin the options selection process. The options guide page may include a brief overview of the options guide page process and may also include a “don't display this page again” option with a corresponding button. If the button has previously been selected, then the data migration utility skips opening the options guide page at Step 124. However, if the “don't display this page again” feature has not been previously selected, the options guide page is displayed at Step 124.

After displaying the options guide page, a patient options page will be opened at Step 126 in FIG. 2 that will allow the user to select the specific patient related options to be applied during data migration. For example, in one exemplary embodiment, shown in FIG. 8, the patient options page allows for the selection of the date ranges of individual patient records to be migrated into the patient's corresponding file in the destination database. The patient options page may further allow the user to select how individual patient information will be migrated into the destination database. For example, the patient options page may provide buttons to allow the user to select whether patient information from the destination database should be kept, whether patient information from the source database should override patient information in the destination database, or whether patient information in the source database should be merged with patient information in the destination database. Further, the user may also be provided with the option to determine whether individual patient settings in the destination database that may apply to features in the corresponding medical management software should be kept, should be overridden by the individual patient options set in the source database, or should be merged with the individual patient options from the source database.

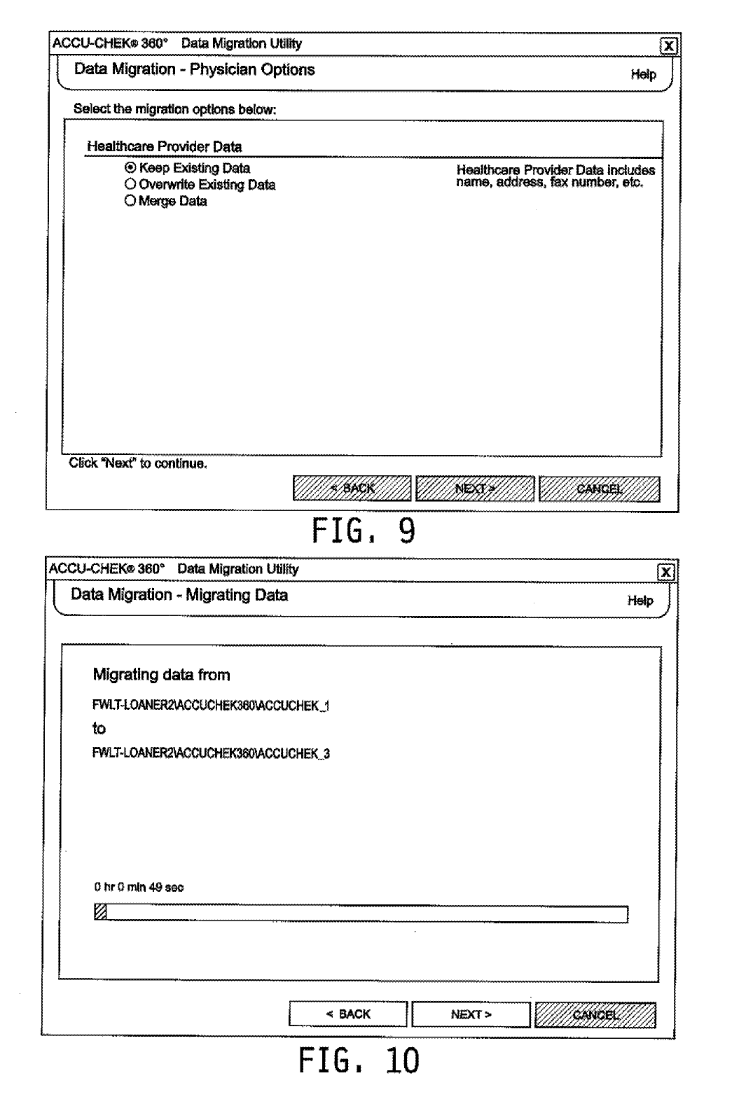

Once the user has selected the desired patient options at the patient options page, a next button may be provided that the user may select, which results in the opening of a physician options page at Step 128. Referring to FIG. 9, the physician options page may provide a series of buttons for determining whether physician information from the destination database should be kept, whether physician information from the source database should override information in the destination database, or whether physician information in the source database should be merged with the physician information in the destination database. Additionally, in one exemplary embodiment, the user is provided with additional options for determining how physician information is handled during data migration.

Once the user has selected the desired physician options at the physician options page, a next button may be provided that the user may select, which results in the opening of a systems options page at Step 130 in FIG. 2. The systems option page may allow the user to select various system options, such as options that relate to the medical management software, that should be applied during data migration. Once the system options have been set at Step 130, a next or finish button may be provided that the user may select to close the systems option page and end the options selection process. While the options selection process has been described and depicted herein as a specific series of screens and options, it is contemplated that any of the options and/or screens described herein may be removed and/or additional screens and/or options may be added.

Once the options selection process has been completed, the data migration process page, shown in FIG. 10, will open and data migration will begin at Step 132 in FIG. 2. The data migration process page may show the identity of the source database by the file path and/or by the filename associated with the source database. Similarly, the data migration process page may also show the identity of the destination database by the file path and/or by the filename associated with the destination database. Additionally, the data migration process page may further provide a status bar that depicts in a graphical format the total amount of data to be migrated as compared to the total amount of data that has been migrated. Further, the data migration process page may provide the total amount of time that the data migration utility estimates the data migration to take and/or the amount of time the data migration utility estimates is remaining until data migration is complete.

Once migration has been initiated at Step 132, the data migration utility will begin importing records from the source database and creating corresponding records in the destination database in accordance with the options selected by the user during the options selection process, as set forth in detail above. Specifically, as set forth above, each record may be encrypted according to an encryption method specific to the individual portable medical device from which the information was originally uploaded. Thus, the data migration utility may decrypt the medical information associated with a first portable medical device that corresponds to an individual patient in the source database and then substantially simultaneously migrate and encrypt the same information into the destination database using the destination database encryption method. This process may then be repeated for subsequent portable medical devices corresponding to the same patient or different patients.

Alternatively, the data migration utility may be configured to decrypt medical information contained in the destination database, if any exists, and add it to a temporary database created by the data migration utility. The data migration utility may also decrypt the medical information contained in the source database and merge it into the medical information migrated into the temporary database from the destination database. Once all the medical information from the source database and the destination database has been merged into the temporary database, the information is re-encrypted using the destination database encryption method and saved in the destination database.

Additionally, during data migration, the data migration utility identifies specific medical information, such as medical information corresponding to an individual patient or healthcare provider, and search the destination database to determine if duplicative or potentially duplicative, i.e., identical or substantially identical, medical information exists in the destination database. In order to determine if duplicative or substantially duplicative medical information exists in the destination database, the data migration utility may utilize the data comparison program. Specifically, as set forth above, the data comparison program may identify at least three categories of patient medical information: unique, duplicate, and potentially duplicate. Alternatively, the data comparison program may provide a numerical rating of the degree of similarity (e.g., 1.0 is a carbon copy, 0.9 is potentially duplicate, 0.8 is highly correlative, etc.). In order to determine the proper classification for each piece of medical information, such as an individual medical record associated with a specific patient, the data comparison program compares the fields associated with the medical information in the source database to the corresponding fields associated with similar medical information in the destination database.

In order to determine if patient medical information in the source database is unique, a duplicate of, or potentially duplicate of patient medical information in the destination database, the data comparison program compares fields for first name, middle name, last name, suffix, date of birth, and unique medical management system identification. Specifically, the data comparison program compares the patient medical information from the source database for an individual patient against the patient medical information from the destination database for a first individual patient. The data comparison program then repeats the comparison of the source database information against a second individual patient in the destination database. This process is repeated until the source database information is compared to the medical information for every individual patient in the destination database. Alternatively, the data comparison program may first start by comparing a key field of the record from the source database with an index of the destination database and only engage in further comparisons if a sufficiently close match is found in the key index of the second database.

In order for the data comparison program to determine that the medical information for an individual patient in the source database is unique as compared to medical information in the destination database, the medical information for the individual patient in the source database must meet any of the following three requirements. First, information in the last name field for the individual patient in the source database must be different from the information in the last name field for every individual patient in the destination database. Second, the information in the date of birth field for the individual patient in the source database must be different from the information in the date of birth field for every individual patient in the destination database. Third, the information in the medical management system identification field for the individual patient in the source database must be both non-null and different from the information in the last name field of every individual patient in the destination database. If any of these three requirements are met, the medical information for the individual patient in the source database is considered unique as compared to the medical information in the destination database and the medical information for the individual patient in the source database is migrated into the destination database and added as a new patient.

Alternatively, if the medical information for the individual patient in the source database is not determined to be unique, the medical information for the individual patient in the source database may be determined to be a duplicate of medical information for the same individual patient that is already in the destination database. In order for the data comparison program to determine that the medical information for an individual patient in the source database is a duplicate of medical information in the destination database, the medical information for the individual patient in the source database must meet one of two conditions. Under the first condition, the medical information is a duplicate if the information in the fields for first name, middle name, last name, suffix, date of birth, and medical management system identification for the individual patient in the source database matches the information in the corresponding fields of the destination database. Alternatively, the information is a duplicate under the second condition if the information in the fields for first name, last name, date of birth, and external identification matches the information in the corresponding fields in the destination database. If either of these conditions are met, the medical information is determined to be duplicative and the patient identified as a duplicate in the data migration utility, as set forth in detail below. However, if the data comparison utility fails to determine that the individual patient's medical information is either unique or duplicative, the medical information is treated as a potential duplicate by the data migration utility.

Similarly, in order to determine if healthcare provider information in the source database is unique, a duplicate of, or a potential duplicate of healthcare provider information in the destination database, the data comparison program compares fields for title, first name, middle name, last name, and suffix. Specifically, the data comparison program compares the healthcare provider information from the source database for an individual healthcare provider against the healthcare provider information from the destination database for a first healthcare provider. The data comparison program then repeats the comparison of the source database information against a second healthcare provider in the destination database. This process is repeated until the source database information is compared to the healthcare provider information for every individual healthcare provider in the destination database.

In order for the data comparison program to determine that the healthcare provider information for an individual healthcare provider in the source database is unique as compared to healthcare provider information in the destination database, the healthcare provider information for the individual healthcare provider in the source database must have information in the last name field that is different from the information in the last name field for every individual healthcare provider in the destination database. If this requirement is met, the healthcare provider information for the individual healthcare provider in the source database is migrated into the destination database and added as a new healthcare provider.

Alternatively, if the healthcare provider information for an individual healthcare provider in the source database is not determined to be unique, the healthcare provider information for the individual healthcare provider in the source database may be determined to be a duplicate of healthcare provider information that is already in the destination database. In order for the data comparison program to determine that the healthcare provider information for an individual healthcare provider in the source database is a duplicate of healthcare provider information in the destination database, the healthcare provider information in the source database must have information in the fields for title, first name, middle name, last name, and suffix that matches the information in the corresponding fields of the destination database. If these conditions are met, the healthcare provider information is determined to be duplicative and the healthcare provider is identified as a duplicate in the data migration utility, as set forth in detail below. However, if the data comparison utility fails to determine that the healthcare provider information is either unique or duplicative, the medical information is treated as a potential duplicate by the data migration utility.

Referring to Step 138 of FIG. 2, if a duplicative, i.e., identical, patient or healthcare provider is identified, the data migration utility pauses migration and determines at Step 140 if the user has previously indicated that all duplicate patients or healthcare providers should be added as new patients or healthcare providers in the destination database. If the answer is yes, migration resumes and a new patient or healthcare provider is created in the destination database. If the answer is no, the data migration utility determines at Step 142 if the potentially duplicate information corresponds to a patient or a healthcare provider.

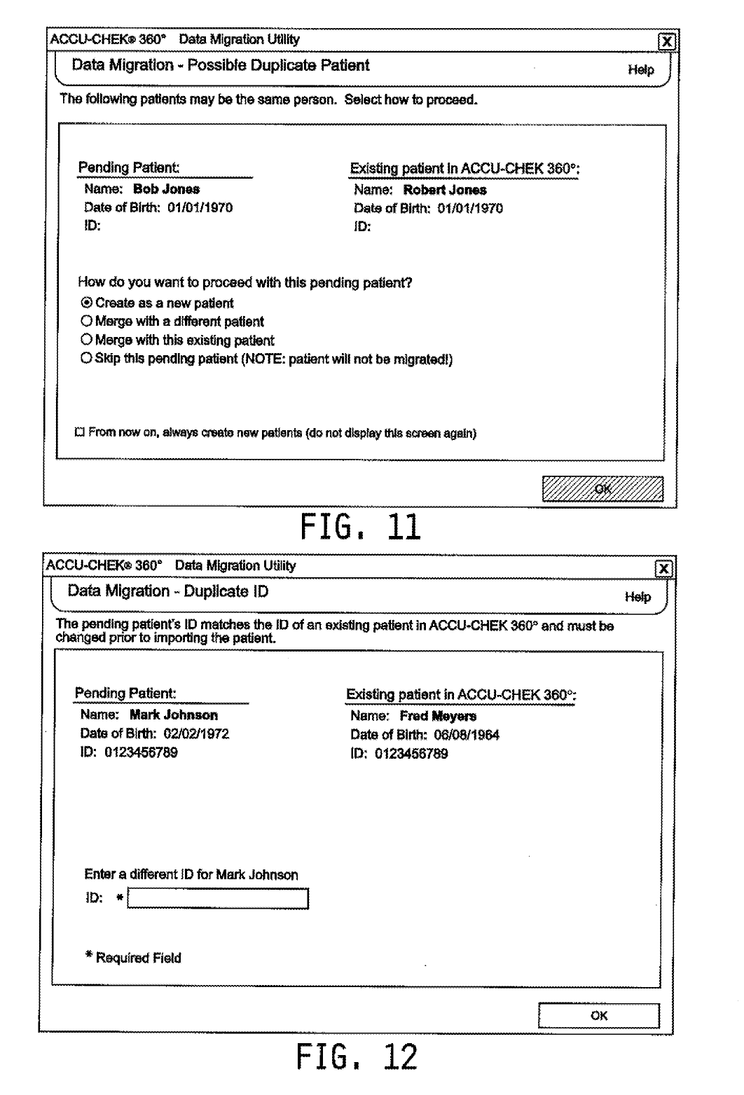

If the information corresponds to a patient, a duplicate patient dialog is opened at Step 144. Referring to FIG. 11, the duplicate patient identification dialog may provide information about the pending patient, i.e., the patient in the source database, such as name, date of birth, and the patient's unique medical management system identification. Similarly, the duplicate patient identification dialog may also provide information about the existing patient, i.e., the patient in the destination database, such as name, date of birth, and the patient's unique medical management system identification. The duplicate patient information dialog may then prompt the user to select the manner in which the record in the source database should be treated. For example, the user may select from adding the pending patient as a new patient in the destination database, selecting another patient from the destination database to merge the pending patient's information with, merging the pending patient with the existing patient, or skipping the pending patient, i.e., leaving the pending patient's information in the source database and not adding the same to the destination database.

Once the user has made the desired selection, the user may select an authorization button, such as the OK button in FIG. 11. Once the authorization button is selected, data migration is resumed. However, if at Step 144, the user indicates that another existing patient in the destination database should be merged with the patient in the source database, then, at Step 148, a select patient dialog is opened that allows the user to select a patient from the destination database into which the pending patient data from the source database is merged.

In one exemplary embodiment, the duplicate patient identification dialog may also include a button that allows the user to avoid the duplicate patient identification dialog for each duplicate patient identified. By selecting this option, each duplicate patient identified by the data migration utility is added as a new patient in the destination database. However, in the event that a pending patient in the source database that is to be added as a new patient in the destination database is determined, at Step 134 in FIG. 2, to have the same medical management system identification as an existing patient in the destination database, a duplicate identification dialog is opened at Step 136 and data migration paused. As shown in FIG. 12, the duplicate identification dialog prompts the user to enter a new medical management system identification for the pending patient before the patient is added as a new patient in the destination database. Once a new patient identification is entered and an authorization provided by the user, such as by selecting the OK button in FIG. 12, data migration resumes and the pending patient in the source database is added as a new patient in the destination database.

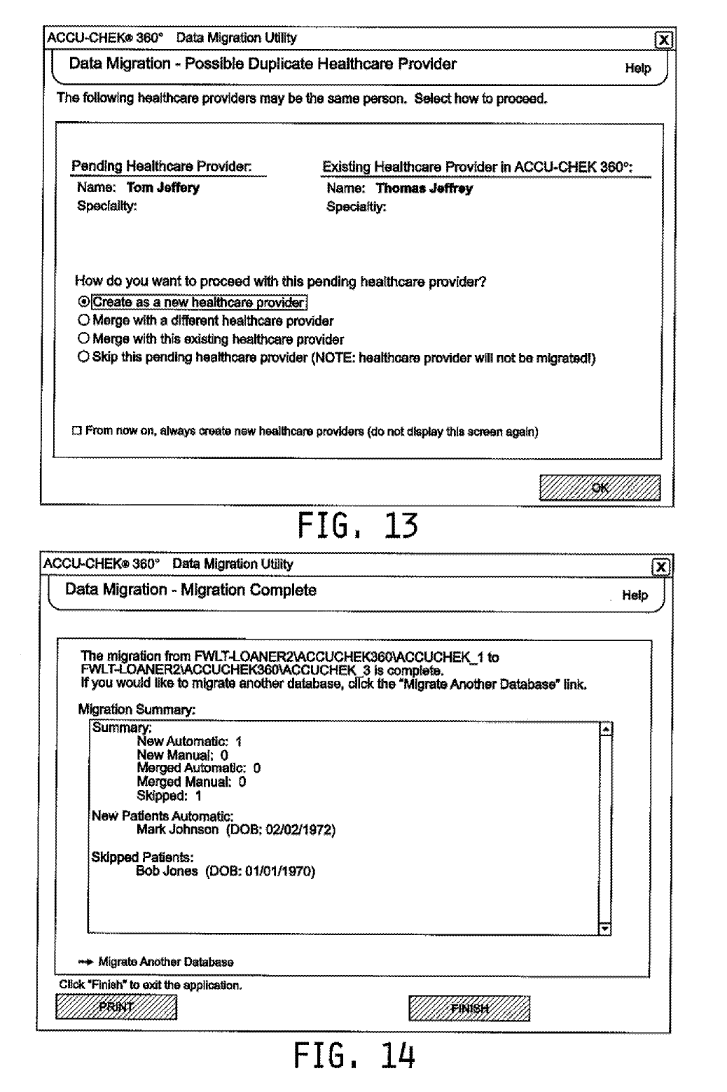

Alternatively, if, at Step 142, the medical information is determined by the data migration utility to correspond to a healthcare provider, then a duplicate healthcare provider dialog is opened at Step 150 and data migration paused. Referring to FIG. 13, the duplicate healthcare provider dialog may provide information about the pending healthcare provider, i.e., the healthcare provider in the source database. Similarly, the duplicate healthcare provider dialog may also provide information about the existing healthcare provider, i.e., the healthcare provider in the destination database. The duplicate healthcare provider dialog may then prompt the user to select the manner in which the healthcare provider information in the source database should be treated. For example, the user may select from: (1) adding the pending healthcare provider as a new healthcare provider in the destination database; (2) selecting another healthcare provider from the destination database to merge the pending healthcare provider's information with, merging the pending healthcare provider with the existing healthcare provider; or (3) skipping the pending healthcare provider, i.e., leaving the pending healthcare provider's information in the source database and not adding the same to the destination database.

Once the user has made the desired selection, the user may authorize the action, such as by selecting the OK button in FIG. 13. Once user authorization is provided, data migration is resumed in accordance with the user's previous selections. However, if the data migration utility determines at Step 152 in FIG. 2 that the user has indicated that another existing healthcare provider should be selected for merging with the pending healthcare provider, a select healthcare provider dialog is opened at Step 154 and the user to allowed to select a different existing healthcare provider from the destination database into which the pending healthcare provider information from the source database is merged.

Additionally, in one exemplary embodiment, the duplicate healthcare provider dialog may also include a button that allows the user to avoid the duplicate healthcare provider dialog for each duplicate healthcare provider identified. By selecting this option, each duplicate healthcare provider identified is added as a new healthcare provider in the destination database.

Further, if at any time during the migration of medical information, the data migration utility identifies a duplicate system definition, such as at Step 156, a duplicate system definition dialog is opened at Step 158 and data migration paused. The duplicate system definition dialog requires that the system definition in the source database is renamed before it can be migrated into the destination database. Once a new name is provided, the user may select an OK button in the duplicate system definition dialog to reinitiate data migration.

Once the migration from the source database to the destination database of all data selected for migration is completed, the data migration utility opens the migration complete page at Step 160. As shown in FIG. 14, the migration complete page may include a listing of the medical information transferred that is separated into categories by patient and healthcare provider. Additionally, the patient category may be further separated by new patients, merged patients, and skipped patients. In one exemplary embodiment, the migration complete dialog also indicates the number of new patients created and/or patients merged automatically and manually. The migration complete page may also provided a detailed listing of patient names for each category, as well as some basic patient information, such as name, date of birth, and the patient's unique identification number. Additionally, in one exemplary embodiment, the data migration complete dialog provides similar information for each healthcare provider identified during the migration.

In order to migrate another database, the user may select the migrate another database option provided by the data migration complete dialog. If the migrate another database option is selected, the migration process is restarted, beginning at Step 104 in FIG. 2. Alternatively, the data migration complete dialog may also include a close or finish button that may be selected by the user to close the data migration utility and end the same at End 162. Further, if at any time during operation of the data migration utility a user attempts to close the same, the data migration utility will close, any information transferred to the destination database is not saved, and the source database is restored.

The system includes a facility to import and export databases, in whole or in part. As in conventional databases, the ability to quickly transfer data is desired. Such export files are typically for transferring information between databases. Optionally, export files may be used to archive portions of databases, portions that are not frequently requested. The quickness of the data transfer is dependant on factors including the speed of the hardware, the organization of the data, and the compatibility of the input and export data. Because the system databases contain many items of personal medical data, the security and integrity of that data also needs to be addressed.

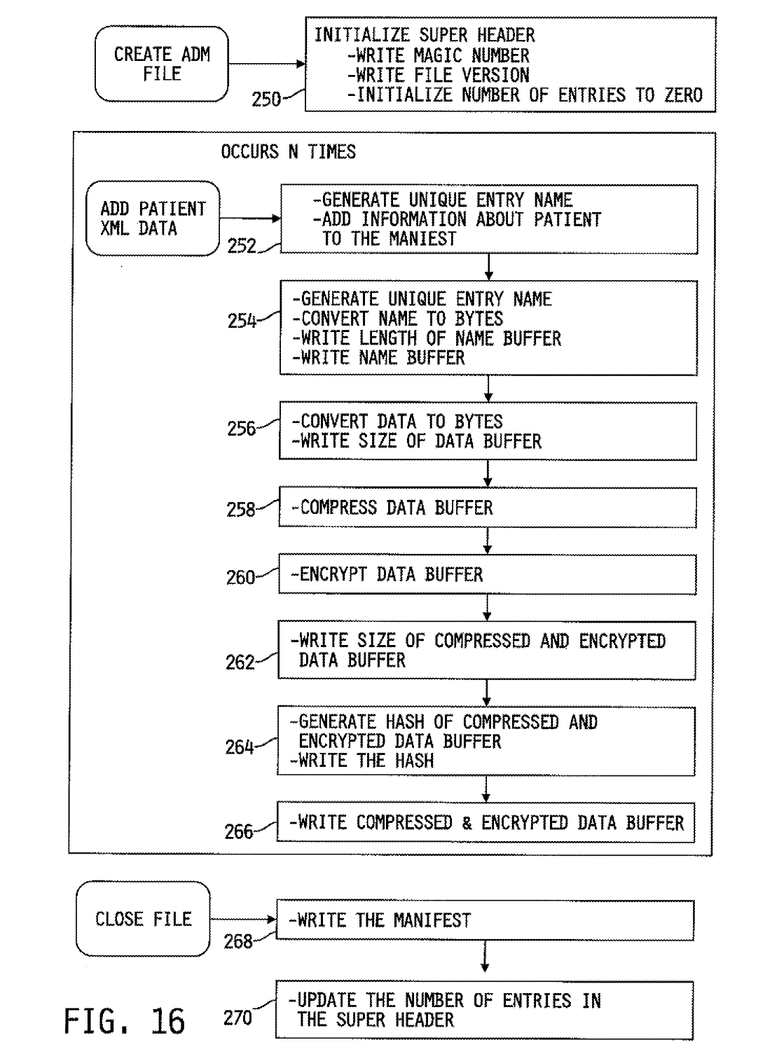

Conventional export files have a header section that includes book-keeping information about the file, and a data section containing the exported information. The export file according to an exemplary embodiment of the present invention is shown in FIG. 16 and advantageously includes manifest section 202 that provides further information about the data being transferred, both index data (typically a personal identifier key) and meta data (data about data, such as data formats, encryption information or hash values).

In the exemplary embodiment of the export file format, header section 204 of the export file contains typical header information. Subsequent patient data sections 206, 208, 210 of the export file format have patient information. Appended at the end, and referenced in the header, is manifest section 202 that includes an index of the patient information sections, encryption information about the patient information sections, and hash values for each of the patient information sections so that the integrity of such patient information may be tested.

Patient data sections 206, 208, 210 are provided in an extensible format, in the manner of XML formatting. Each patient information section 206, 208, 210 is encrypted along with the extensible information, using either the same encryption key or separate encryption keys. Optionally, the encrypted sections may be compressed using a compression algorithm. Several types and variations of encryption and compression may be used within the scope of the present invention.

Typically, key management is provided at the export file level, but that the actual keys are at the “home” of the data (the originating computer). Thus, if patient data from a first computer is exported, the resulting export file has a pointer to the first computer's encryption key. When the receiving program at a second computer attempts to import the contents of the export file, it presents its credentials to the first computer A and asks for the key. Assuming the receiving program has appropriate credentials, the first computer then provides a key to decrypt the data, which is then encrypted with the second computer's encryption key and stored in the second computer's database. Alternatively, key management for export files may be maintained in the decoding library of the medical management software on computer 12, or may be a part or object within the medical management software itself. It is also possible to use other encryption schemes, such as encrypting the patient data with the sending computer's private key and the receiving computer's public key, so that the receiving computer may use the public key of the sending computer with its own private key to decrypt the patient information. Thus, other encryption scheme implementations are also possible.

The creation of an export file is depicted in the flow chart of FIG. 16. Starting at Step 250, an ADM file is created. Specifically, as indicated at Step 250, the header is initialized, which includes writing the magic number, writing the file version, and setting the initialize number of patient entries to zero. Once the header is initialized, patient XML data is added to the ADM file.

Referring to Step 252, a unique entry name is generated for the patient data and the information about the patient is added to the manifest. Then, at Step 254, the unique entry name generated at Step 252 is converted to bytes, the length of the name buffer is written, and the name buffer itself is written. Continuing to Step 256, the patient XML data is then converted into bytes and the size of the data buffer is written. The data buffer is then compressed at Step 258 and encrypted at Step 260. Once the data buffer is compressed and encrypted, Step 260 is performed and the size of the compressed and encrypted data buffer is written. Hash values for the data buffer are then generated and the hash values are written at Step 264. At Step 266, the compressed and encrypted data buffer is written. This process, i.e., the addition of patient XML data, is then repeated for each patient.

Once Steps 252-266 have been performed for each patient, the file is closed. Specifically, at Step 268, the manifest is written. The number of patient entries is then updated in the header at Step 270.

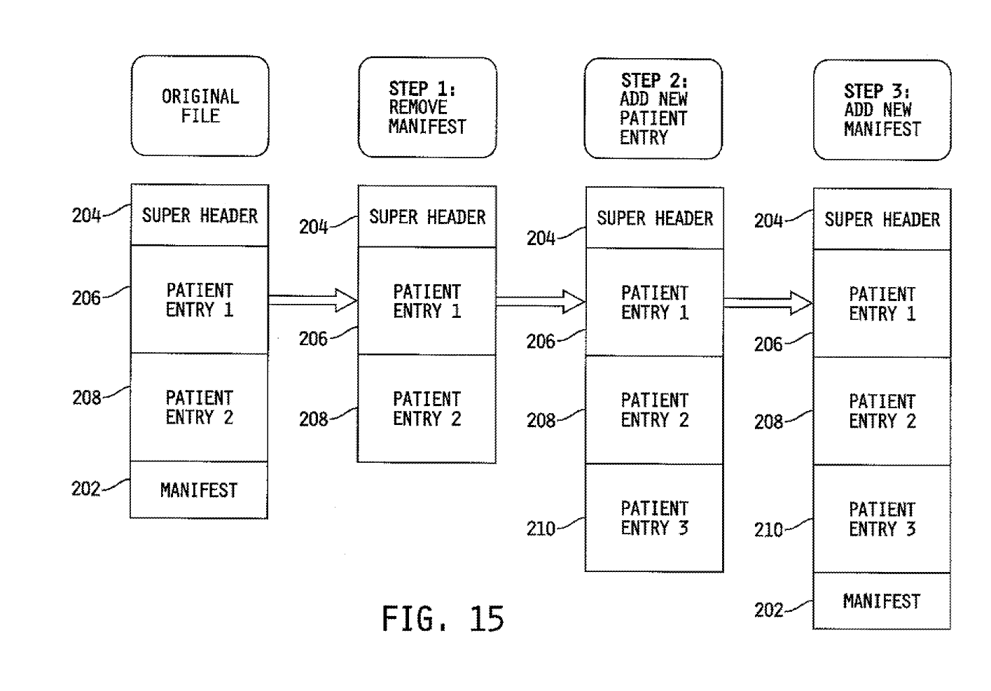

In one embodiment of the invention, the export file is an object that has at least three methods or operations that may be performed. Referring to FIG. 15, the create operation involves establishing header section 204, adding one or more patient information sections 206, 208, 210, then creating manifest section 202 by indexing the patient identifier keys with the corresponding data locations and including the appropriate extensible, encryption, and/or hash information. Upon creating manifest section 202, header section 204 is updated with a pointer to manifest 202 at the end of the export file.

Referring to FIG. 15, another operation is the add patient operation, wherein new patient information 210 is appended to last patient information section 208 at Step 2, manifest 202 is updated to include new patient information 210 and relocated after newly added patient information 210 at Step 3, and header 204 is updated to reflect the new location of manifest 202.

A third operation involves reading the contents of the export file, which is accomplished by accessing header 204 to locate manifest 202, and accessing the index of manifest 202 to locate the appropriate patient section 206, 208, 210, and using manifest 202 information to decode and verify the contents of the desired patient information 206, 208, 210 so that the patient information is the result of the operation.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A computer system for obtaining and extracting health care maintenance information from a portable patient device, said system including:
a computer;
a database coupled to said computer;
means for obtaining health care maintenance information from a portable patient device; and
a data export program, said data export program having instructions for creating an export file to include the health care maintenance information, said data export program having instructions to create a header portion of said export file, at least one health care maintenance information portion of said export file, and a manifest portion of said export file.

2. The computer system of claim 1 wherein said data export program includes instructions for including an index of health care maintenance information in said manifest portion.

3. The computer system of claim 1 wherein said data export program includes instructions for including decryption information for the health care maintenance information in said manifest portion.

4. The computer system of claim 1 wherein said data export program includes instructions for including hash values relating to the integrity of the health care information.

5. The computer system of claim 1 wherein said data export program includes instructions for including a plurality of health care information portions in said export file.

6. The computer system of claim 5 wherein said data export program includes instructions for including a pointer to said manifest portion in said header portion.

7. The computer system of claim 1 wherein said data export program includes instructions for including meta data relating to the health care maintenance information in said at least one health care maintenance portion of said export file.

8. The computer system of claim 1 wherein said data export program includes instructions for adding new patient information in said export file.

9. A method of creating an export file for patient health care maintenance information comprising the steps of:
creating a header for the export file;
appending at least one health care maintenance record associated with a patient to the header; and
creating a manifest, including an index of patients having a health care maintenance record in the export file, at the end of the export file; and
updating the header with a pointer to the manifest.

10. The method of claim 9 wherein said creating a manifest step includes incorporating decryption information in the manifest.

11. The method of claim 9 wherein said creating a manifest step includes calculating hash values relating to the integrity of the at least one health care maintenance record.

12. The method of claim 9 wherein said appending step includes appending meta data relating to the at least one health care maintenance record.

13. The method of claim 9 wherein said appending step includes creating a new patient record and including the new patient record in the export file.

14. A computer system for obtaining exported health care maintenance information from a portable patient device, said system including:
a computer;
a database coupled to said computer;
means for obtaining an export file having health care maintenance information from a portable patient device; and
a data import program, said data import program having instructions for reading an export file having the health care maintenance information, said data import program having instructions to read at least one health care maintenance information portion of said export file and a manifest portion of said export file.

15. The computer system of claim 14 wherein said data import program includes instructions for accessing an index of health care maintenance information in the manifest portion.

16. The computer system of claim 14 wherein said data import program includes instructions for obtaining decryption information for the health care maintenance information in said manifest portion.

17. The computer system of claim 14 wherein said data import program includes instructions for evaluating hash values in the manifest portion relating to the integrity of the health care information.

18. The computer system of claim 14 wherein said data import program includes instructions for extracting a plurality of health care information portions in said export file.

19. The computer system of claim 18 wherein said data import program includes instructions for extracting a pointer to said manifest portion from said header portion.

20. The computer system of claim 14 wherein said data import program includes instructions for extracting meta data relating to the health care maintenance information in said at least one health care maintenance portion of said export file.

21. The computer system of claim 24 wherein said data import program includes instructions for extracting new patient information in said at least one health care maintenance portion of said export file.

22. A method of extracting information from an export file having patient health care maintenance information comprising the steps of:
reading a header in the export file to obtain a pointer to the manifest;
accessing the manifest to obtain an index of patients having a health care maintenance record in the export file; and
using the patient index to obtain at least one health care maintenance record relating to a specified patient.

23. The method of claim 22 wherein said using step includes obtaining decryption information relating to the specified patient in the manifest.

24. The method of claim 22 wherein said using step includes using a hash value relating to the specified patient at least one health care maintenance record to verify the integrity of the at least one health care maintenance record.

25. The method of claim 22 further including a step of obtaining meta data relating to the at least one health care maintenance record to organize the health care maintenance information relating to the specified patient.

26. The method of claim 22 further including a step of obtaining new patient information from the export file.
